(19) United States
(12) Patent Application Publication
(10) Pub. No.: US 2023/0288072 A1
(43) Pub. Date: Sep. 14, 2023

(54) PELLET-FIRED HEATING SYSTEMS AND APPLIANCES

(71) Applicant: CANADIAN TIRE CORPORATION, LIMITED, Toronto (CA)

(72) Inventor: Jim SCOTT, Cambridge (CA)

(21) Appl. No.: 18/018,408

(22) PCT Filed: Jul. 30, 2020
(86) PCT No.: PCT/CA2020/051045

§ 371 Date: Jan. 27, 2023

(51) Int. Cl. F24C 1/04; F24B 1/20; F23B 40/00; F24B 13/04; F23B 80/04; F24B 5/02; F23C 1/04; A47J 37/07; A23B 4/052

(52) U.S. Cl. CPC F24C 1/04; F24B 1/20; F23B 40/00; F24B 13/04; F23B 80/04; F24B 5/023; F23C 1/04; A47J 37/0713; A47J 37/0786; A23B 4/052

(57) ABSTRACT

Systems and methods of a pellet-fired heating include a system having a combustion chamber in which combustion gas is generated from fuel pellets. The combustion chamber includes a fuel inlet for receiving fuel pellets into the combustion chamber, an air inlet for receiving air into the combustion chamber, and a combustion gas outlet for discharging combustion gas from the combustion chamber. The system further includes a first radiator extending into a space to be heated having an internal passage in fluid communication with the combustion chamber, via the combustion gas outlet, and one or more discharge outlets for discharging the combustion gas from the internal passage into the space. A blower of the system is configured to push air into the combustion chamber via the air inlet and push the combustion gas from the combustion chamber into the internal passage of the first radiator.

### TECHNICAL FIELD

The disclosure relates generally to pellet-fired heating systems, and associated appliances such as cooking grills.

### BACKGROUND

Wood pellet grills are used as outdoor cooking grills in which fuel pellets and air are fed to a fire pot in which combustion of the pellets occurs. The heat generated from the combustion of the pellets is used to heat a cooking area of the pellet grill. Pellet grill temperatures are typically controlled by controlling the amount of fuel being consumed and by regulating of airflow to the fire pot. While pellet grills have advantageous features and are often preferred over other types of grills, some existing pellet grills have drawbacks such as non-uniform heating across larger cooking surfaces and the inability to generate temperatures that are high enough for searing food. Improvement is desirable.

### SUMMARY

In one aspect, the disclosure describes a cooking grill comprising:
a cooking chamber; and
a pellet-fired heating system for heating the cooking chamber, the pellet-fired heating system including:
a combustion chamber in which combustion gas is generated from the combustion of fuel pellets, the combustion chamber including a fuel inlet for receiving the fuel pellets into the combustion chamber, an air inlet for receiving air into the combustion chamber, and a combustion gas outlet for discharging combustion gas from the combustion chamber;
a radiator extending into the cooking chamber, the radiator including an internal passage in fluid communication with the combustion gas outlet of the combustion chamber, and a discharge outlet for discharging the combustion gas from the internal passage; and
a blower in fluid communication with the air inlet of the combustion chamber and configured to: push air into the combustion chamber via the air inlet and push the combustion gas out of the combustion chamber via the combustion gas outlet.

The radiator may be a first radiator. The internal passage may be a first internal passage and the discharge outlet may be a first discharge outlet. The system may comprise:
a second radiator having a second internal passage in fluid communication with the combustion chamber, the second radiator having a second discharge outlet for discharging the combustion gas from the second internal passage; and
a valve actuatable to change proportions of combustion gas pushed into the first and second radiators.

The valve may be disposed inside the combustion chamber.

A straight portion of the first internal passage of the first radiator may be substantially parallel to a straight portion of the second internal passage of the second radiator.

The cooking grill may comprise a conveyor in communication with the fuel inlet of the combustion chamber and operable to deliver the fuel pellets to the combustion chamber.

The conveyor may be disposed inside a conduit establishing fluid communication between the blower and the air inlet.

The radiator may have an elongated shape. The discharge outlet may be one of a plurality of discharge outlets distributed along the radiator.

The cooking grill may comprise a heat deflector adjacent the radiator. The heat deflector may intersect an axis defining orientation of the discharge outlet.

The fuel pellets may be a first fuel of a first fuel type and the cooking grill may include a burner for heating the cooking chamber. The burner may be configured to facilitate combustion of a second fuel of a second fuel type different from the first fuel type.

The burner may be a gas burner.

The burner and the radiator may be disposed inside the cooking chamber.

The burner and the radiator may be elongated. The burner and the radiator may be oriented transversely to each other.

Embodiments may include combinations of the above features.

In another aspect, the disclosure describes an outdoor space heater comprising:
a heating volume; and
a pellet-fired heating system for heating the heating volume, the pellet-fired heating system including:
a combustion chamber in which combustion gas is generated from the combustion of fuel pellets, the combustion chamber including a fuel inlet for receiving the fuel pellets into the combustion chamber, an air inlet for receiving air into the combustion chamber, and a combustion gas outlet for discharging combustion gas from the combustion chamber;
a radiator extending into the heating volume, the radiator including an internal passage in fluid communication with the combustion gas outlet of the combustion chamber, and a discharge outlet for discharging the combustion gas from the internal passage; and
a blower in fluid communication with the air inlet of the combustion chamber and configured to: push air into the combustion chamber via the air inlet and push the combustion gas out of the combustion chamber via the combustion gas outlet.

The outdoor space heater may comprise an air-permeable cover enclosing the heating volume.

The cover may include one or more walls made of a metallic mesh.

The outdoor space heater may comprise a base and the heating volume may be disposed vertically above the base.

The radiator may include a straight tubular portion extending vertically.

The radiator may be a first radiator. The straight tubular portion may be a first straight tubular portion. The outdoor space heater may include a second radiator extending into the heating volume. The second radiator may include a second straight tubular portion substantially parallel to the first straight tubular portion.

The outdoor space heater may comprise a heat deflector adjacent the radiator. The heat deflector may intersect an axis defining orientation of the discharge outlet.

The radiator may have a helical tubular portion.

The radiator may be a first radiator. The helical tubular portion may be a first helical tubular portion. The outdoor space heater may include a second radiator extending into the heating volume. The second radiator may include a second helical tubular portion intertwined with the first helical tubular portion.

The outdoor space heater may comprise an ash receptacle for receiving ash from the combustion chamber.

The outdoor space heater may comprise:
a base, the heating volume being disposed vertically above the base; and
a drawer movably received into the base, the drawer defining an ash receptacle for receiving ash from the combustion chamber.

Embodiments may include combinations of the above features.
In a further aspect, the disclosure describes a pellet-fired heating system comprising:
a combustion chamber in which combustion gas is generated from the combustion of fuel pellets, the combustion chamber including a fuel inlet for receiving the fuel pellets into the combustion chamber, an air inlet for receiving air into the combustion chamber, and a combustion gas outlet for discharging combustion gas from the combustion chamber;
a radiator extending into a space to be heated, the radiator including an internal passage in fluid communication with the combustion gas outlet of the combustion chamber, and a discharge outlet for discharging the combustion gas from the internal passage; and
a blower in fluid communication with the air inlet of the combustion chamber and configured to: push air into the combustion chamber via the air inlet and push the combustion gas out of the combustion chamber and into the radiator via the combustion gas outlet.

The radiator may be a first radiator. The internal passage may be a first internal passage and the discharge outlet may be a first discharge outlet. The system may comprise:
a second radiator having a second internal passage in fluid communication with the combustion chamber, the second radiator having a second discharge outlet for discharging the combustion gas from the second internal passage; and
a valve actuatable to change proportions of combustion gas pushed into the first and second radiators.

The valve may be disposed inside the combustion chamber.

A straight portion of the first internal passage of the first radiator may be substantially parallel to a straight portion of the second internal passage of the second radiator.

The pellet-fired heating system may comprise a conveyor in communication with the fuel inlet of the combustion chamber and operable to deliver the fuel pellets to the combustion chamber.

The conveyor may be disposed inside a conduit establishing fluid communication between the blower and the air inlet.

The radiator may have an elongated shape. The discharge outlet may be one of a plurality of discharge outlets distributed along the radiator.

The radiator may have a proximal end proximal to the combustion chamber and a distal end distal of the combustion chamber. The distal end of the radiator may be capped.

The internal passage may include a first straight portion, a bend and a second straight portion disposed series.

The first and second straight portions may be substantially perpendicular.

The first and second straight portions may be substantially parallel.

The pellet-fired heating system may comprise a heat deflector associated with the radiator. The heat deflector may intersect an axis defining orientation of the discharge outlet.

The fuel pellets may be a first fuel of a first fuel type and the pellet-fired heating system may include a burner for heating the space. The burner may be configured to facilitate combustion of a second fuel of a second fuel type different from the first fuel type.

The burner may be a gas burner.

The burner and the radiator may be elongated. The burner and the radiator may be oriented transversely to each other.

Embodiments may include combinations of the above features.

In a further aspect, the disclosure describes a method of heating with fuel pellets. The method comprises:
delivering the fuel pellets into a combustion chamber;
pushing air into the combustion chamber;
generating combustion gas from combustion of the fuel pellets in the combustion chamber;
receiving the combustion gas from the combustion chamber into a radiator extending into a space;
using the radiator to radiate heat carried by the combustion gas; and
discharging the combustion gas from the radiator.

The radiator may be a first radiator and the method may comprise:
receiving proportions of the combustion gas from the combustion chamber respectively into the first radiator and a second radiator extending into the space;
radiating the heat carried by the combustion gas using both the first radiator and the second radiator; and
discharging the combustion gas from the first and second radiators.

The method may comprise adjusting the proportions of the combustion gas respectively received into the first radiator and the second radiator.

The method may comprise using a common blower to push the air to the combustion chamber and to push the combustion gas into the radiator.

The method may comprise pushing a flame generated in the combustion chamber into the radiator.

The method may comprise discharging the flame into the space from a discharge outlet formed in the radiator.

The method may comprise deflecting heat released from the discharge outlet.

The space may be a cooking chamber of a cooking grill.

The fuel pellets may be a first fuel of a first fuel type and the method may include heating the space using a second fuel of a second fuel type different from the first fuel type.

The second fuel type may be a fluid.

The method may comprise combusting the second fuel inside the space.

The method may comprise discharging the combustion gas from the radiator into the space.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a perspective view of an exemplary pellet-fired heating system;

FIG. 2 is a cross-sectional view of the pellet-fired heating system of FIG. 1 taken along line 2-2 of FIG. 1;

FIG. 3 is a flow chart of an exemplary method of heating;

FIG. 4 is a photograph of the pellet-fired heating system of FIG. 1 integrated inside a cooking chamber;

FIG. 5 is a photograph of the pellet-fired heating system of FIG. 1 in operation;

FIG. 6 is a top view plan view of part of another exemplary pellet-fired heating system;

FIG. 7 is a perspective view of another exemplary pellet-fired heating system;

FIG. 8 is a perspective view of another exemplary pellet-fired heating system;

FIG. 9 is a perspective view of another exemplary pellet-fired heating system;

FIGS. 10A-10C are schematic views of part of the pellet-fired heating system of FIG. 9 respectively showing a valve in three different positions for directing the combustion gas toward one, another or both radiators;

FIG. 11 is a perspective view of an exemplary heating system having a pellet-fired heating system and a gas-fired heating system;

FIG. 12 top view of the heating system of FIG. 11;

FIG. 13 is a perspective view of the heating system of FIG. 11 integrated into a cooking chamber;

FIG. 14 is a perspective view of a cooking grill including the heating system of FIG. 11;

FIG. 15 is a cross sectional view of the cooking grill of FIG. 14 taken along line 15-15 of FIG. 14;

FIG. 16 is a perspective view of an exemplary outdoor space heater;

FIG. 17 is a perspective view of the outdoor space heater of FIG. 16, with a cover omitted;

FIG. 18 is a perspective view of the outdoor space heater of FIG. 16, with the cover and heat deflectors omitted; and

FIG. 19 is a perspective view of another exemplary outdoor space heater;

FIG. 20 is a perspective view of the outdoor space heater of FIG. 19, with a cover omitted.

### DETAILED DESCRIPTION

The following disclosure describes pellet-fired heating systems, methods and associated appliances such as cooking grills. In various embodiments, the systems and methods described herein make use of one or more radiators for heating a space such as a cooking chamber. In some embodiments, the systems and methods described herein may promote relatively uniform heating over larger cooking surfaces and may also facilitate higher temperatures that may be suitable for searing food. In some embodiments, the systems and methods described herein may facilitate selective heating of different zones within a space to be heated. Some embodiments of the heating systems described herein may also be used in other appliances such as outdoor space heaters and fireplaces for example.

Hereinafter, the term “connected” or “coupled to” may include both direct coupling (in which two elements that are coupled to each other contact each other) and indirect coupling (in which at least one additional element is located between the two elements). The term “substantially” as used herein may be applied to modify any quantitative representation which could permissibly vary without resulting in a change in the basic function to which it is related.

Aspects of various embodiments are described below through reference to the drawings.

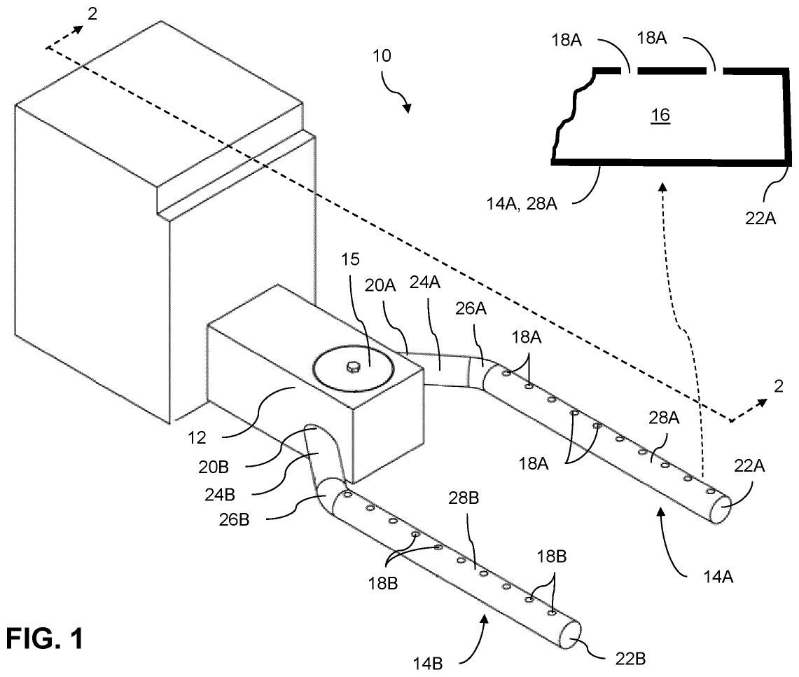

FIG. 1 depicts a perspective view of an exemplary pellet-fired heating system 10 (referenced hereinafter as “pellet system 10”) for heating a space and/or object within a space. Pellet system 10 may be incorporated into a cooking grill or other appliance. Pellet system 10 may include combustion chamber 12 in which combustion gas is generated from the combustion of fuel (e.g., wood) pellets, and one or more radiators 14A, 14B extending into the space. Cover 15 may be removably disposed over combustion chamber 12 to close a top of combustion chamber 12 while still allowing access to combustion chamber 12 for cleaning or inspection. Radiators 14A, 14B may each include internal passage 16 in fluid communication with combustion chamber 12 so that combustion gas and the flame generated inside combustion chamber 102 may be received (e.g., pushed) into radiators 14A, 14B and discharged from radiators 14A, 14B via one or more discharge outlets 18A, 18B. Radiators 14A, 14B may facilitate a desired distribution of the heat generated in combustion chamber 12.

FIG. 1 also includes an inset schematically showing part of first radiator 14A including internal passage 16 and discharge openings 18A establishing fluid communication between internal passage 16 and the space surrounding radiators 14A, 14B. Second radiator 14B may have a similar or identical construction as that shown in the inset and may also have internal passage 16.

Radiators 14A, 14B may each have an elongated shape and a plurality of discharge outlets 18A, 18B distributed along the elongated shape. In various embodiments, discharge outlet 18A, 18B may be through holes of circular or other shape defined in radiators 14A, 14B. In some embodiments, discharge outlets 18A, 18B may include one or more through slits defined in radiators 14A, 14B.

Radiators 14A, 14B may be tubes that have a substantially circular cross-sectional profile. Alternatively, radiators 14A, 14B may have a non-circular (e.g., oval, rectangular) cross-sectional profile. Radiators 14A, 14B may have substantially identical or different cross-sectional profiles. Radiators 14A, 14B may be made from a metallic material such as (e.g., stainless) steel, other alloy(s) or other material suitable for the operating conditions. Radiators 14A, 14B may be formed by cutting, bending and/or welding tubular pieces together to achieve the desired configuration of radiators 14A, 14B. Discharge outlets 18A, 18B may be drilled into the tubular pieces.

Radiators 14A, 14B may be shaped and configured (e.g., routed) to have any layout that accommodates the size and configuration of the space to be heated. Radiators 14A, 14B may have straight and/or curved portions. In some embodiments, radiators 14A, 14B may have respective proximal ends 20A proximal to combustion chamber 12 and respective distal ends 22A distal of combustion chamber 12. Radiators 14A, 14B and their associated internal passages 16 may have respective first straight portions 24A, 24B, bends 26A, 26B and second straight portions 28A, 28B disposed series. In some embodiments, second straight portion 28A of first radiator 14A may be substantially parallel to second straight portion 28B of second radiator 14B.

Radiators 14A, 14B may be attached to combustion chamber 12 or other structure of system 10 by any suitable means such as welding or fastening. In some embodiments, radiators 14A, 14B may be removably fastened to combustion chamber 12 or other structure.

In some embodiments, radiators 14A, 14B could be connected together so that respective internal passages 16 are combined to form a loop instead of separate branches. Alternatively, distal ends 22A, 22B of respective radiators 14A, 14B may be capped so that the combustion gas and flames may be forced to exit radiators 14A, 14B via discharge openings 18A, 18B. The number, size and location of discharge openings 18A, 18B may be selected based on an expected flow rate of combustion gas pushed into radiators 14A, 14B and desired heat distribution and performance. In some situations, it may be desirable that the configuration of discharge openings 18A, 18B be selected so that, in use, each internal passage 16 serves as a plenum in which the combustion gas is accumulated and discharged via discharge openings 18A, 18B at relatively similar flow rates. Such relatively even distribution of combustion gas among discharge openings 18A, 18B may promote a relatively uniform heating along radiators 14A, 14B and throughout the space to be heated. Desired configurations of discharge openings 18A, 18B for different applications and situations may be determined experimentally or using numerical modeling and simulation. As an example, the discharge openings 18A, 18B may be about 0.375″ (1 cm) in diameter, and the discharge openings 18A, 18B may be spaced about 2″ (5 cm) apart along the radiators 14A, 14B, from center to center. It is understood that other hole diameters, shapes and spacings could also be used.

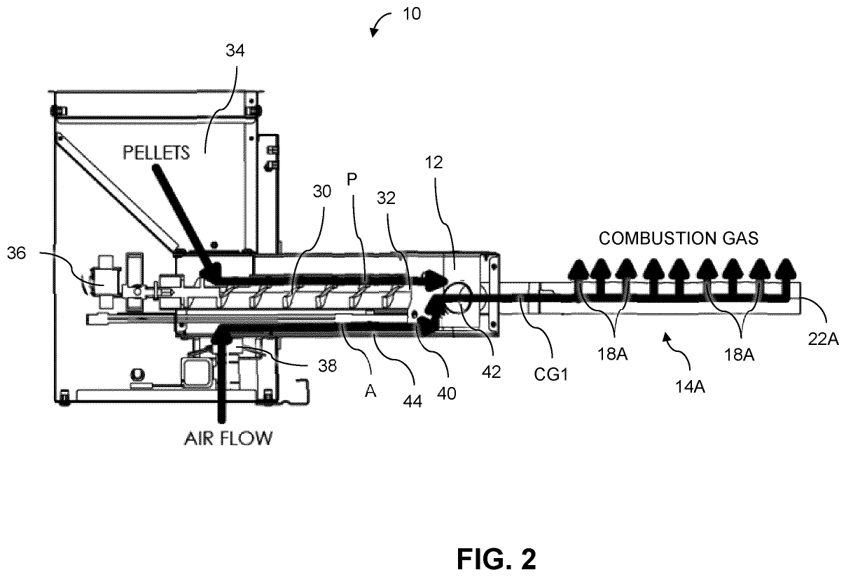

FIG. 2 is a cross sectional view of pellet system 10 taken along line 2-2 of FIG. 1. Pellet system 10 may include conveyor 30 in communication with fuel inlet 32 of combustion chamber 12 and operable to deliver the pellets from hopper 34 to combustion chamber 12. In some embodiments, conveyor 30 includes a screw conveyor (i.e., auger) including a shaft with a helical flange rotating within a cylindrical casing to propel the pellets toward combustion chamber 12. Conveyor 30 may be driven via motor 36 drivingly coupled to conveyor 30. Motor 36 may be an electric motor. Motor 36 may be a variable speed motor that is controllable to provide a desired feed rate of pellets to combustion chamber 12 based on a desired heat output from pellet system 10. The flow of pellets from hopper 34 to combustion chamber 12 is indicated by arrow P. Pellet system 10 may accommodate pellet fuels including biofuels made from compressed organic matter or biomass. In some embodiments, wood pellets such as those generally made from compacted sawdust may be suitable for consumption by pellet system 10.

Pellet system 10 may include blower 38 in fluid communication with one or more air inlets 40 (referred hereinafter in the singular) of combustion chamber 12 and configured to draw ambient air and push the air into combustion chamber 12 via air inlet 40. Blower 38 may be electrically driven. Blower 38 may include a fan and an electric motor. The operating speed of blower 38 may be adjustable in order to vary the flow rate of air provided to combustion chamber 12. For example, the operating speed of conveyor 30 and of blower 38 may be coordinated so that the flow rate of air delivered to combustion chamber 12 may be coordinated with the feed rate of pellets delivered to combustion chamber 12 to sustain the combustion process. The flow of air delivered to combustion chamber 12 is indicated by arrow A.

In some embodiments of pellet system 10, conveyor 30 may be disposed inside air conduit 44 establishing fluid communication between blower 38 and air inlet 40 if combustion chamber 12. For example, conveyor 30 and its outer casing may define a fuel passage that is separate from the air passage defined by air conduit 44 but that extends within air conduit 44. For example, the fuel passage may extend substantially coaxially with air conduit 44. In other words, conveyor 30 may define a smaller tube extending within and along a larger tube (i.e. air conduit 44) defining an annular air passage. Alternatively, conveyor 30 may be disposed outside of air conduit 44.

Combustion chamber 12 may include one or more combustion gas outlets 42 establishing fluid communication between combustion chamber 12 and internal passages 16 of radiators 14A, 14B. During operation of pellet system 10, blower 38 may push air into combustion chamber 12 and also cause the combustion gas to be pushed out of combustion chamber 12 via combustion gas outlet(s) 42 and into radiator(s) 14A, 14B. For example, the flow of combustion gas delivered to (e.g., pushed into) radiator 14A is indicated by arrow CG1.

Pellet system 10 may include a hot surface igniter also known as a “Hot Rod” igniter, or other type of igniter suitable for initiating and/or maintaining combustion inside combustion chamber 12.

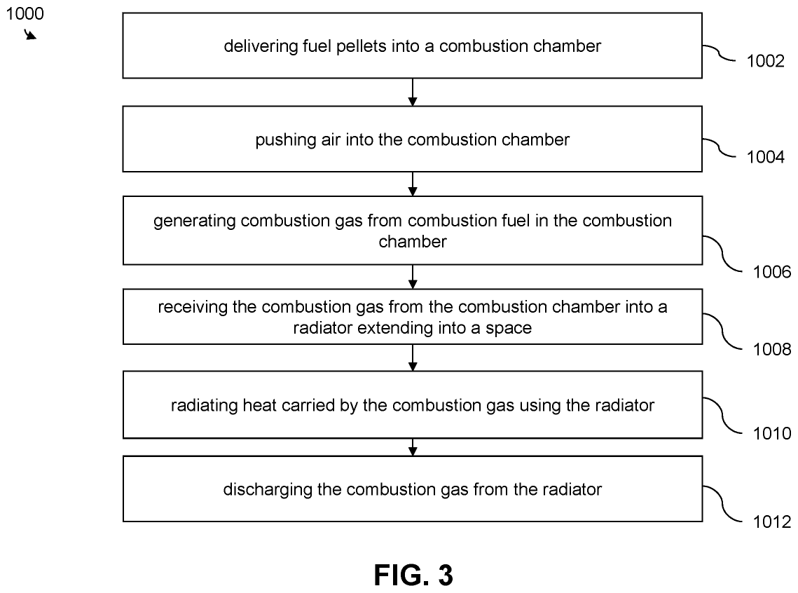

FIG. 3 is a flow chart of an exemplary method 1000 of heating. Method 1000 may be carried out using pellet system 10 or other pellet system described herein. In reference to FIGS. 2 and 3, method 1000 may include: delivering fuel pellets from hopper 34 into combustion chamber 12 (see block 1002); pushing air into combustion chamber 12 (see block 1004); generating combustion gas from the combustion of the fuel pellets in combustion chamber 12 (see block 1006); receiving the combustion gas from combustion chamber 12 into one or more radiators 14A, 14B extending into a space (see block 1008); radiating heat carried by the combustion gas into the space using the one or more radiators 14A, 14B (see block 1010); and discharging the combustion gas from the one or more radiators 14A, 14B (see block 1012).

In some embodiments, method 1000 may include receiving proportions of the combustion gas from combustion chamber 12 respectively into first radiator 14A and second radiator 14B extending into the space. The heat carried by the combustion gas may be radiated via both radiators 14A, 14B. Similarly, the combustion gas may be discharged from discharge outlets 18A, 18B of both radiators 14A, 14B. The combustion gas may be discharged from radiators 14A, 14B and into the space to be heated.

In some embodiments, a single common blower 38 may be used to perform both functions of pushing the air to combustion chamber 12 and also pushing the combustion gas into radiators 14A, 14B. For example, as shown in FIG. 2, blower 38, air conduit 44, combustion chamber 12 and at least one of radiators 14A, 14B may be in serial flow communication. Other than fuel inlet(s) 32, air inlet(s) 40 and combustion gas outlet(s) 42, combustion chamber 12 may be substantially closed (e.g., via cover 15) so that the fluid driving force generated by blower 38 may also drive the combustion gas out of combustion gas outlet(s) 42. In other words, the combustion gas generated inside combustion chamber 12 may have no exit other than combustion gas outlet(s) 42 leading to radiators 14A, 14B. In some situations, a flame generated in combustion chamber 12 may also get pushed into radiators 14A, 14B and discharged into the space from one or more discharge outlets 18A, 18B formed in radiators 14A, 14B.

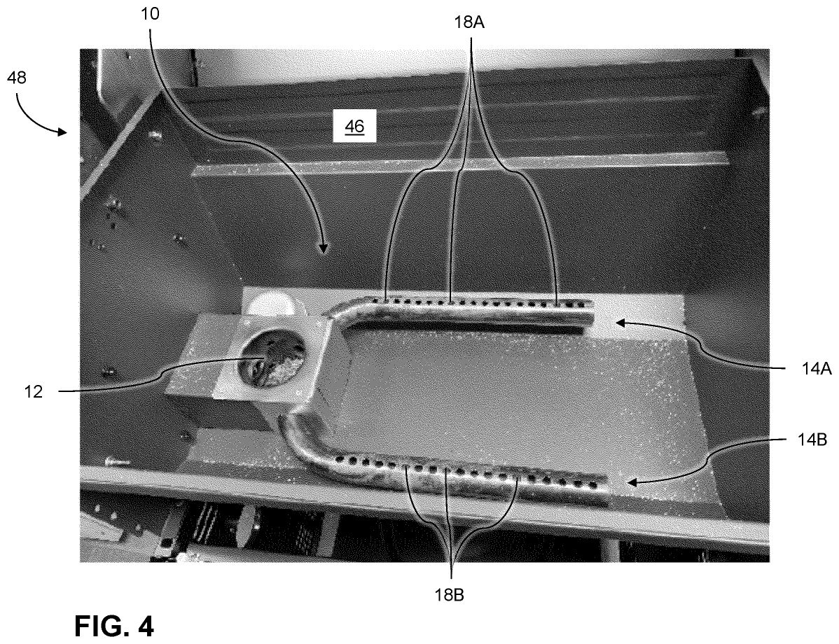

FIG. 4 is a photograph of part of pellet system 10 integrated inside cooking chamber 46 of cooking grill 48. A cooking grate of the cooking grill 48 has been removed from cooking chamber 46 to clearly show the placement of combustion chamber 12 and radiators 14A, 14B within cooking chamber 46. In some embodiments, radiators 14A, 14B may be disposed under the cooking grate and discharge outlets 18A, 18B may be oriented generally upwardly toward the cooking grate. FIG. 4 shows cover 15 being removed to expose an interior of combustion chamber 12. FIG. 4 shows pellet system 10 in an non-operating state.

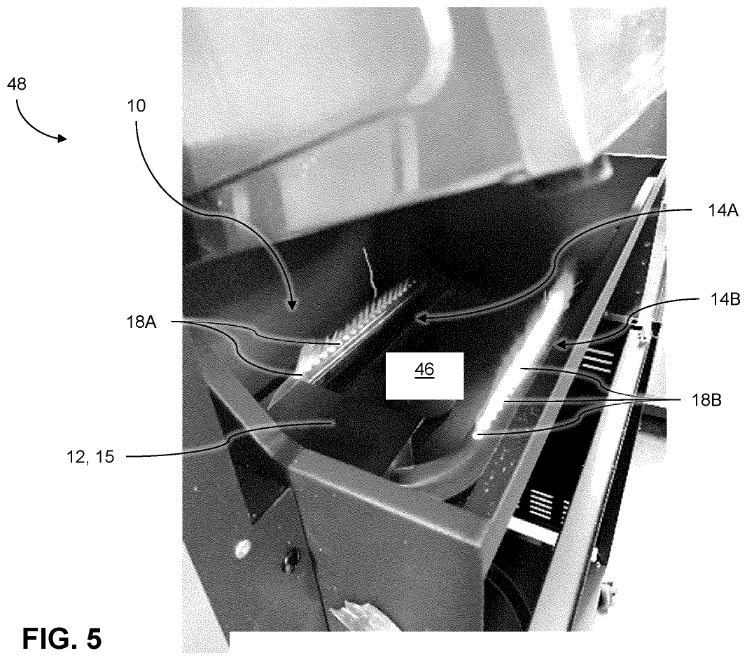

FIG. 5 is a photograph of part of pellet system 10 integrated inside cooking chamber 46 of cooking grill 48 when pellet system 10 is in operation. The cooking grate of the cooking grill 48 has been removed from cooking chamber 46 to illustrate the operating state of radiators 14A, 14B. During operation of pellet system 10, combustion gas and a flame generated inside combustion chamber 12 may be pushed into radiators 14A, 14A and discharged into cooking chamber 46 via discharge outlets 18A, 18B. The relatively hot combustion gas may cause radiators 14A, 14B to heat up as well and emit/radiate heat through electromagnetic radiation. In other words, the relatively hot radiators 14A, 14B may function as infrared heaters that transfer heat to other objects within cooking chamber 46 such as a cooking grate, walls of cooking chamber 46 and/or food items disposed inside cooking chamber 46, by infrared heating. In the operating state shown in FIG. 5, radiators 14A, 14B are made of stainless steel and have reached a temperature where they have adopted a glowing red color due to the heating provided by the combustion gas. Radiators 14A, 14B may be made from other metallic materials (e.g., steel).

FIG. 5 also shows flames being released out of discharge outlets 18A, 18B. The flames generated inside of combustion chamber 12 may be pushed into radiators 14A, 14B by blower 38. The discharge of hot combustion gas from discharge outlets 18A, 18B may additionally provide heating to cooking chamber 46 by way of convection.

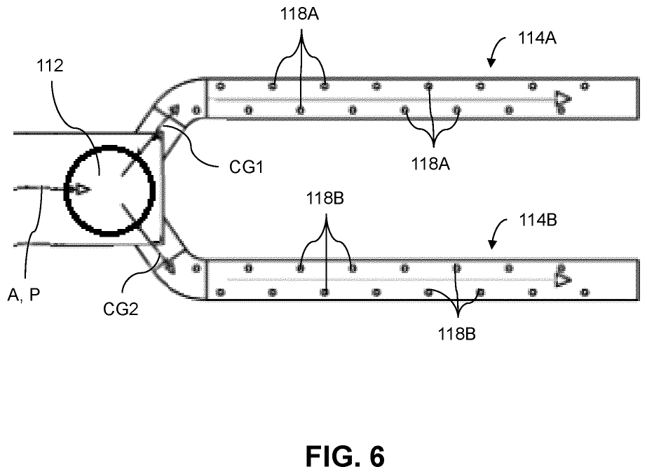

FIG. 6 is a top view of other exemplary radiators 114A, 114B having a different distribution of discharge outlets 118A, 118B than those of radiators 14A, 14B. In relation to pellet system 10 described above, reference characters identifying like elements have been incremented by 100. Instead of a single row of discharge outlets, radiators 114A, 114B each have two rows of discharge outlets 118A, 118B extending along each radiator 114A, 114B. It is understood that various arrangement of discharge outlets 118A, 118B may be suitable for different applications. The arrangement of radiators 114A, 114A extending from combustion chamber 112 may together define a substantially U-shaped infrared heating element during use. The horizontal arrangement of radiators 114A, 114B and the locations of discharge outlets 118A, 118B may promote an upward heating direction. The flow of combustion gas delivered to (e.g., pushed into) radiator 114A is indicated by arrow CG1, and the flow of combustion gas delivered to (e.g., pushed into) radiator 114B is indicated by arrow CG2.

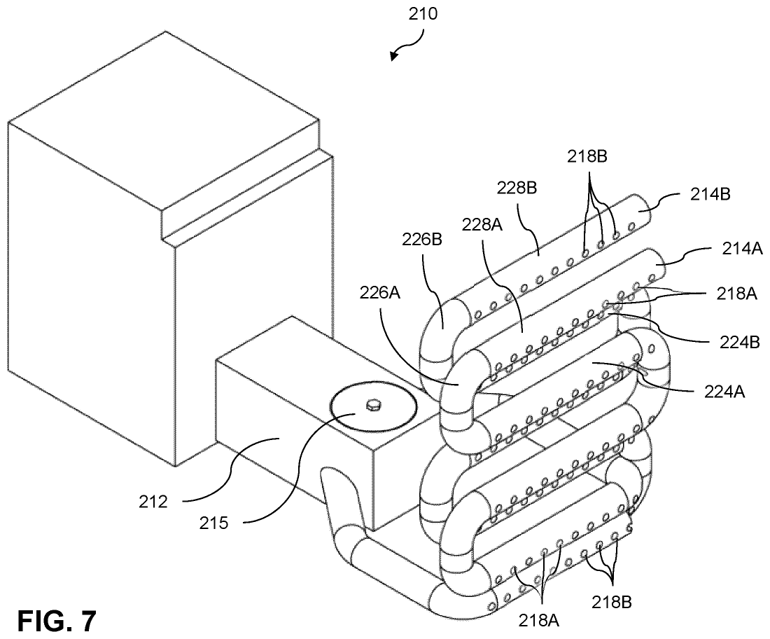

FIG. 7 is a perspective view of another exemplary pellet-fired heating system 210 showing another exemplary configuration of radiators 214A, 214B. In relation to pellet system 10 described above, reference characters identifying like elements have been incremented by 200. Here, the vertical arrangement of radiators 214A, 214B and the locations of discharge outlets 218A, 218B may promote a lateral heating direction. Pellet system 210 may be suitable for use as or integration into a fireplace or an outdoor space heater for example. Pellet system 210 may include combustion chamber 212, cover 215, a conveyor (not shown) and a blower (not shown).

Radiators 214A, 214B (and their associated internal passages) may have respective first straight portions 224A, 224B, bends 226A, 226B and second straight portions 228A, 228B disposed series. In some embodiments, first straight portions 224A, 224B may be substantially parallel to each other. In some embodiments, second straight portions 228A, 228B may be substantially parallel to each other. In some embodiments, first straight portion 224A may be substantially parallel to second straight portion 228A. Similarly, first straight portion 224B may be substantially parallel to second straight portion 228B. Radiators 214A, 214B and their associated internal passages may each define a zig-zag pattern extending substantially vertically. Radiators 214A, 214B may each have perforated straight portions that are connected in series and that are oriented about 180° apart. In some embodiments, radiators 214A, 214B may be laterally and vertically offset from each other to provide an increased laterally-facing frontal heating area.

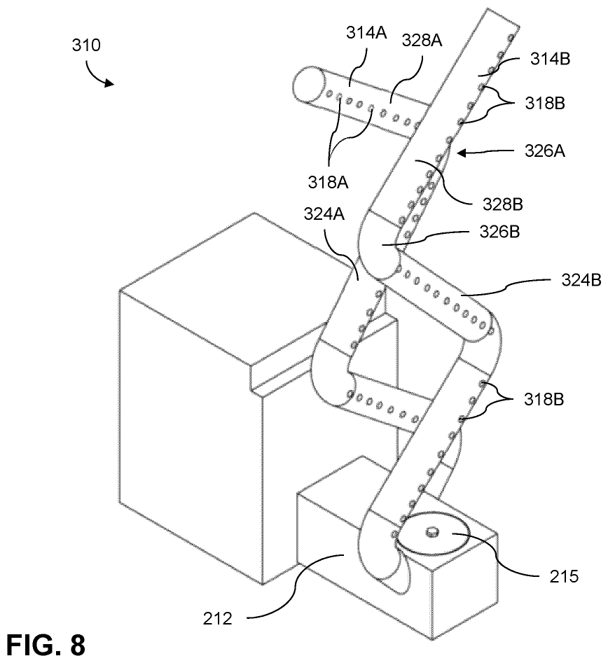

FIG. 8 is a perspective view of another exemplary pellet-fired heating system 310 showing another exemplary configuration radiators 314A, 314B. In relation to pellet system 10 described above, reference characters identifying like elements have been incremented by 300. Here, the vertical arrangement of radiators 314A, 314B and the locations of discharge outlets 318A, 318B may also promote a lateral heating direction. Pellet system 310 may be suitable for use as or integration into a fireplace or an outdoor space heater for example. Pellet system 310 may include combustion chamber 312, cover 315, a conveyor (not shown) and a blower (not shown).

Radiators 314A, 314B (and their associated internal passages) may have respective first straight portions 324A, 324B, bends 326A, 326B and second straight portions 328A, 328B disposed series. In some embodiments, first straight portions 324A, 324B may be substantially perpendicular to each other. In some embodiments, second straight portions 328A, 328B may be substantially perpendicular to each other. In some embodiments, first straight portion 324A may be substantially perpendicular to second straight portion 328A. Similarly, first straight portion 324B may be substantially perpendicular to second straight portion 328B. Radiators 314A, 314B and their associated internal passages may each define a zig-zag pattern extending substantially vertically from combustion chamber 12. Radiators 314A, 314B may each have perforated straight portions that are connected in series and that are oriented about 90° apart. In some embodiments, radiators 314A, 314B may be laterally offset from each other to provide an increased laterally-facing frontal heating area.

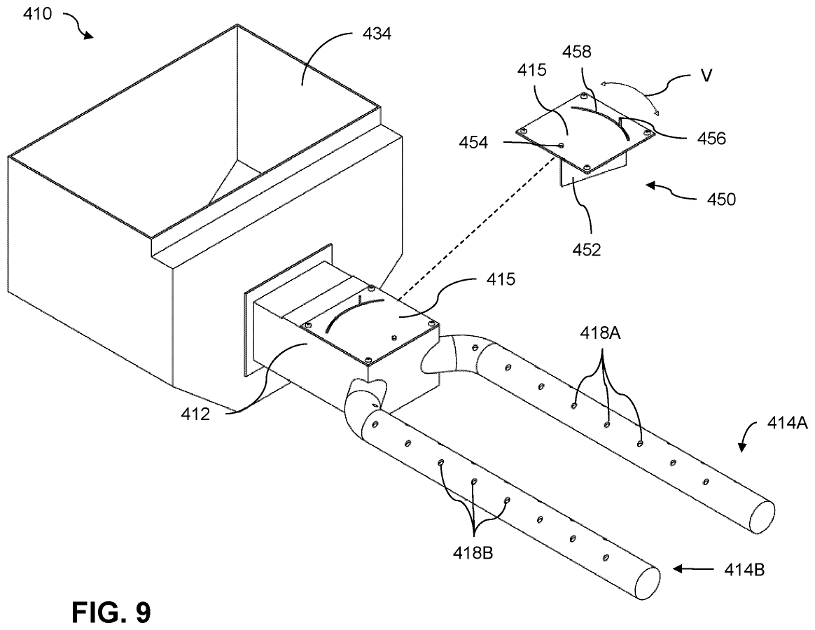

FIG. 9 is a perspective view of another exemplary pellet-fired heating system 410 including valve 450 disposed inside combustion chamber 412. Valve 450 is shown separately of the rest of pellet system 410 as an inset in FIG. 9. In relation to pellet system 10 described above, reference characters identifying like elements have been incremented by 400. Optional valve 450 or other functionally similar device may be incorporated in any systems described herein. Pellet system 410 may include combustion chamber 412, cover 415, hopper 434, a conveyor (not shown) and a blower (not shown). Cover 415 may be secured in place via one or more threaded fasteners.

Valve 450 may be operable (e.g., actuatable) to adjust the proportions of the combustion gas respectively received (e.g., pushed) into first radiator 414A and second radiator 414B. In some embodiments, valve 450 may include baffle 452 movably mounted inside of combustion chamber 412. For example, baffle 452 may be rotatable about pivot pin 454 that may be engaged with cover 415. Slide pin 456 may be attached to baffle 425 and movably received through slot 458 defined in cover 415. Slot 458 may have an arcuate shape having a center substantially coaxial with pivot pin 454 so that movement of slide pin 456 along slot 458 may cause rotational movement of baffle 452 as represented by arrow V.

In order to adjust the position of baffle 452, slide pin 456 may be moved manually along slot 458 by an operator of pellet system 410. In some embodiments, where pellet system 410 is integrated into a cooking chamber, baffle 452 may be manually actuatable by the operator from a safe location via a suitable linkage, rod, lever or knob operatively coupled to baffle 452. Alternatively, baffle 452 may be operatively coupled to an electric motor controllable by the operator via a suitable interface.

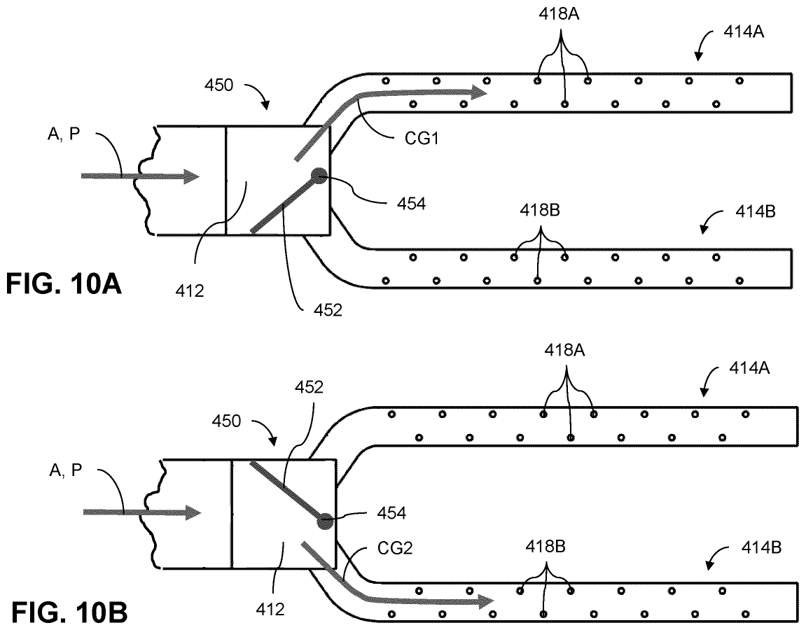

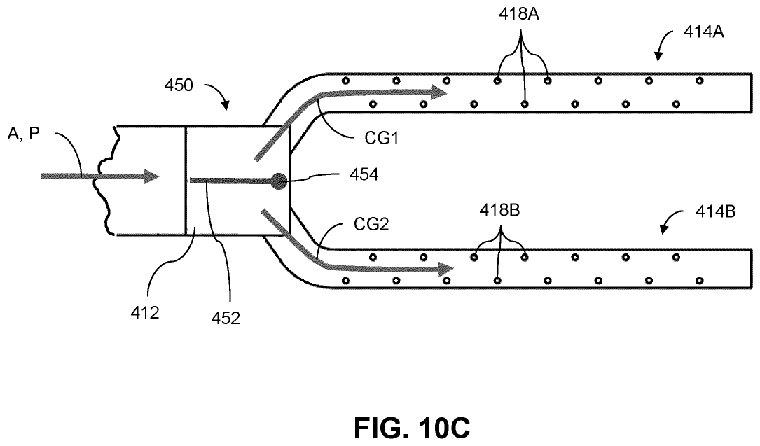

FIGS. 10A-10C are schematic views of part of pellet system 410 respectively showing valve 450 in three different positions for directing the combustion gas toward one, the other or both of radiators 414A, 414B. FIGS. 10A-10C show cover 415 of combustion chamber 412 being omitted to expose the interior of combustion chamber 412 and baffle 452. FIG. 10A shows baffle 452 at a first position where a greater proportion of combustion gas is being directed to first radiator 414A as opposed to second radiator 414B, as baffle 452 is positioned to impede the flow of combustion gas into second radiator 414B. The flow of combustion gas to first radiator 414A is indicated by arrow CG1. The flow of pellets and air to combustion chamber 412 is indicated by arrow A, P. FIG. 10B shows baffle 452 at a second position where a greater proportion of combustion gas is being directed to second radiator 414B as opposed to first radiator 414A, as baffle 452 is positioned to impede the flow of combustion gas into first radiator 414A. The flow of combustion gas to second radiator 414B is indicated by arrow CG2. The flow of pellets and air to combustion chamber 412 is indicated by arrow A, P. In some embodiments, valve 450 may be positioned to substantially completely block the flow of combustion gas to one or the other radiator 414A, 414B.

In some embodiments, valve 450 may be positioned at intermediate positions between those shown in FIGS. 10A, 10B to vary the proportions of combustion gas pushed to radiators 414A, 414B. FIG. 100 shows a middle position of baffle 452 where about equal proportions of combustion gas are being directed to first radiator 414A and to second radiator 414B. The flow of combustion gas to first radiator 414A is indicated by arrow CG1. The flow of combustion gas to second radiator 414B is indicated by arrow CG2.

The use of valve 450 may allow for controlling the amount of heat being delivered to different zones within the space (e.g., cooking chamber 46). It is understood that pellet system 410 may include more than two radiators 414A, 414B and that different configurations of valve 450 may be implemented to vary proportions of combustion gas delivered to more than two radiators 414A, 414B.

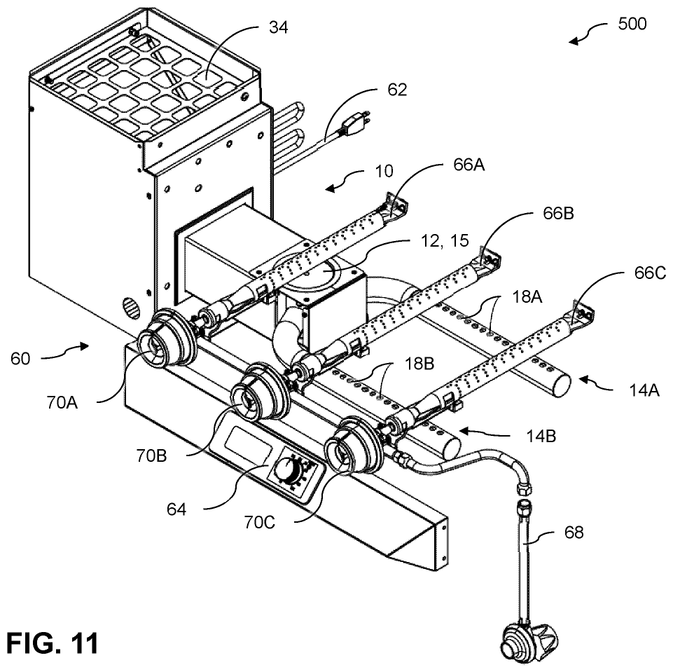

FIG. 11 is a perspective view of an exemplary heating system 500 having pellet system 10 and a gas-fired heating system 60 (referred hereinafter as “gas system 60”) for heating a space such as a cooking chamber for example. In various embodiments, heating system 500 may include other pellet systems 210, 310 and 410 described herein. In some embodiments, pellet system 10 of heating system 500 may include valve 450 described above. Heating system 500 may include pellet system 10 and a second heating system configured to burn a type of fuel different from pellets such as a fluid (e.g., gas) for example. In various embodiments, such second heating system may be gas system 60 and may be configured to burn propane and/or natural gas for example.

In some embodiments, pellet system 10 may be electrically-powered and may include power cord 62 configured to connect into a household electrical outlet. Pellet system 10 may also include (e.g., digital) controller 64 operatively coupled to motor 36 and fan 38 (shown in FIG. 2) so that operating parameters such as operating speed and run time of motor 36 and fan 38 may be controlled. Controller 64 may provide an operator interface.

Gas system 60 may include one or more gas burners 66A-66C for heating the space to be heated. Gas burners 66A-66C may be fluidly connectable to a source of propane or natural gas via gas line 68 and respective valves controllable via knobs 70A-70C. In some embodiments, gas burners 66A-66C may be fluidly connectable to a fuel reservoir (e.g., propane tank) via pressure regulator 69 which serves to regulate (e.g., reduce) the pressure of the gas being supplied to gas burners 66A-66C from the fuel reservoir. Each knob 70A-70C may be associated with a respective gas burner 66A-66C so that gas flow to gas burners 66A-66C may be individually controlled. Alternatively, a single one of knobs 70A-70C may associated with a plurality of gas burners 66A-66C.

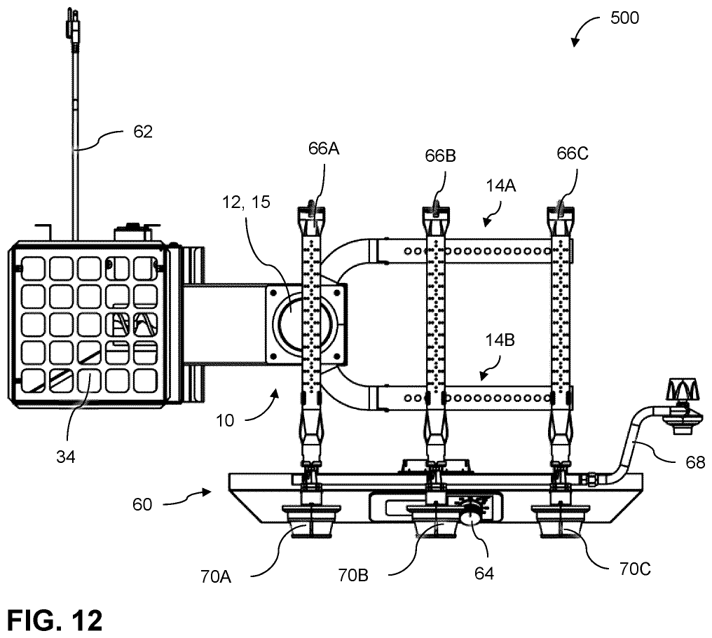

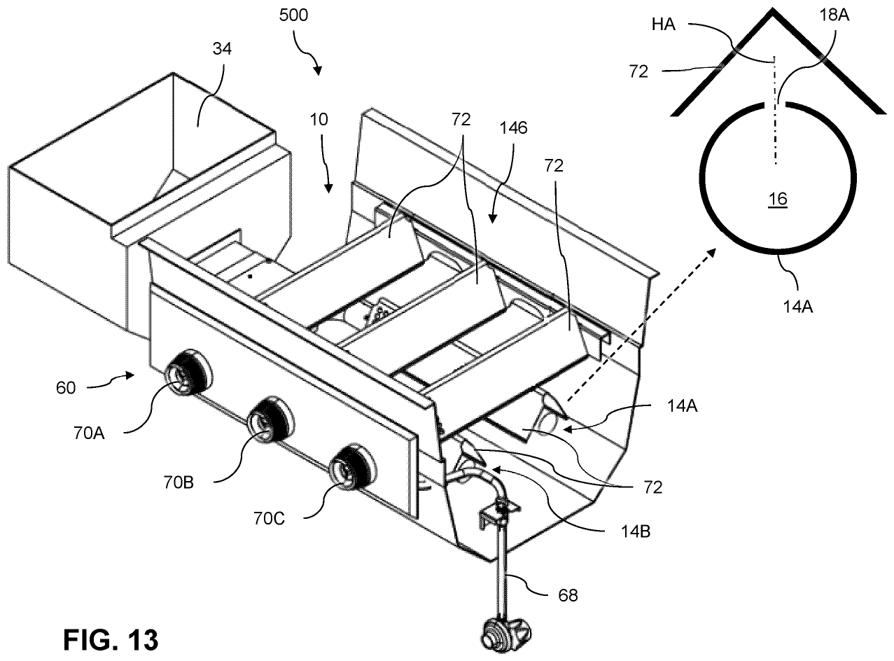

FIG. 12 top view of heating system 500. Gas burners 66A-66C may be generally linear elongated members. Gas burners 66A-66C may each include a perforated tubular structure in which gas is received. Gas burners 66A-66C may each have a plurality of apertures from which the gas is discharged and combusted within the space to be heated. The use of multiple gas burners 66A-66C that are spaced apart and also individually controllable may allow control over the amount of heat being delivered to different zones within the space. In some embodiments, gas burners 66A-66C may overlay radiators 14A, 14B of pellet system 10. In some embodiments, gas burners 66A-66C may be oriented transversely to radiators 14A, 14B.

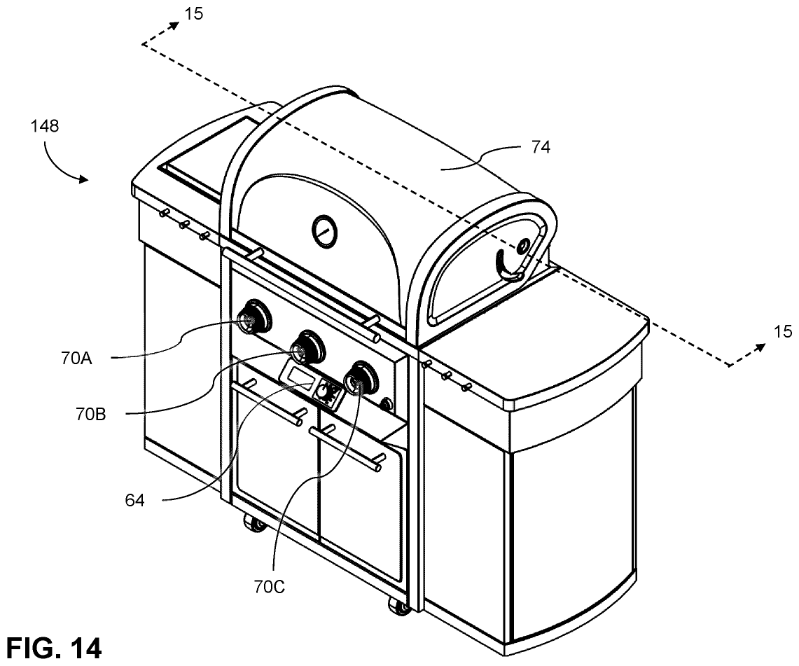

FIG. 13 is a perspective view of heating system 500 integrated into cooking chamber 146 of cooking grill 148 (shown in FIG. 14). In some embodiments, heating system 500 may include optional heat deflectors 72 that may be respectively disposed over some or all of gas burners 66A-66C. Similarly, optional heat deflectors 72 may be respectively disposed over some or all of radiators 14A, 14B. In some embodiments, heat deflectors 72 may include metallic (e.g., stainless steel) plates or sheets disposed over gas burners 66A-66C and/or over radiators 14A, 14B. Heat deflectors 72 may be of the type known as “heat shields”, “heat tents” and “flame tamers” and may serve to disperse the heat produced by gas burners 66A-66C or the heat released by radiators 14A, 14B. The use of heat deflectors 72 may promote more even heating across cooking chamber 146.

A exemplary cross-sectional schematic representation of heat deflector 72 together with first radiator 14A is shown in the inset of FIG. 13. Heat deflector 72 may have an upside down V-shaped or caret-shaped cross-sectional profile. Heat deflector 72 may be disposed above first radiator 14A with a gap defined between heat deflector 72 and first radiator 14A. Heat deflector 72 may intersect axis HA defining an orientation of discharge outlet 18A.

FIG. 14 is a perspective view of cooking grill 148 including heating system 500. Parts of heating system 500 may be disposed inside cooking chamber 146 defined under lid 74, and inside cabinet portions of cooking grill 148.

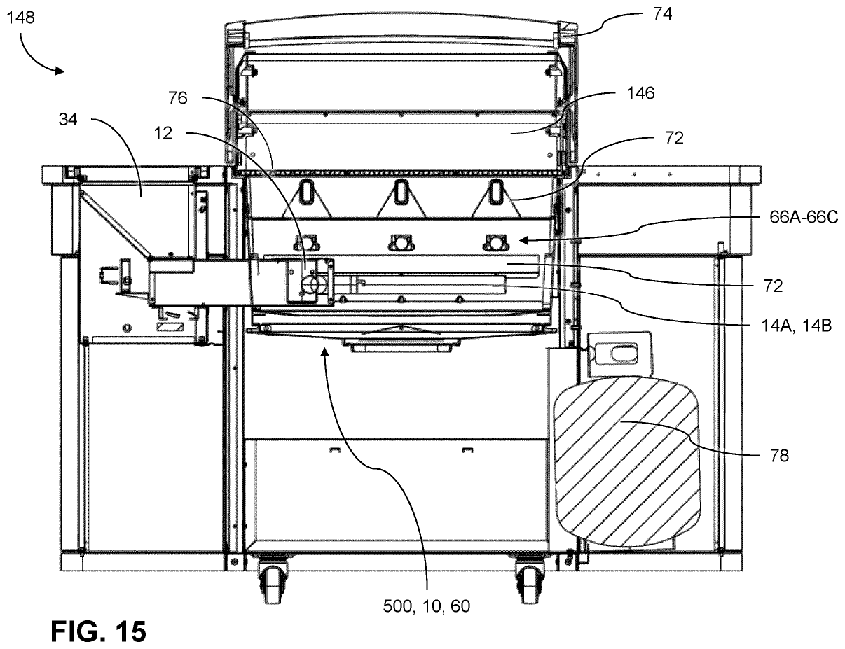

FIG. 15 is a cross sectional view of cooking grill 148 taken along line 15-15 of FIG. 14. Cooking grill 148 may include the arrangement of heating system 500 and cooking chamber 146 shown in FIG. 13. For example, both gas burners 66A-66C and radiators 14A, 14B may be disposed inside cooking chamber 146. Gas burners 66A-66C and radiators 14A, 14B may be disposed under cooking grate 76. Gas burners 66A-66C may be disposed closer to grate 76 than radiators 14A, 14B. For example, gas burners 66A-66C may be disposed between radiators 14A, 14B and grate 76. Fuel (e.g., propane) tank 78 may be fluidly connectable to gas burners 66A-66C via gas line 68 and valves controllable via knobs 70A-70C (shown in FIG. 14).

During operation, cooking grill 148 may provide some versatility such that the same cooking grill 148 may be used either as a pellet grill or as a gas grill depending the type of cooking task at hand and the operator's preference. For example, pellet system 10 and gas system 60 may be operable independently from each other. Pellet system 10 and gas system 60 may be operated at different times. Alternatively, both pellet system 10 and gas system 60 may be operated simultaneously if desired. Such simultaneous operation of pellet system 10 and gas system 60 may be desired when it is desired to cook objects in the cooking grill 148 with the gas system 60, while also infusing smoke or smoke flavouring from the pellet system 10 operation.

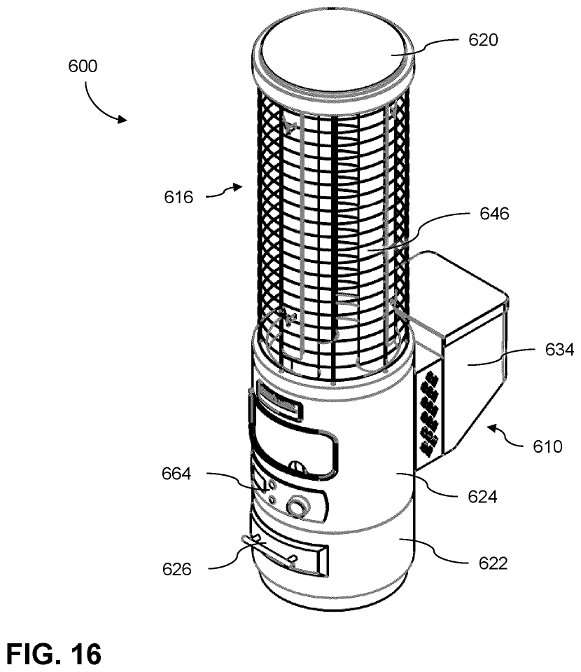

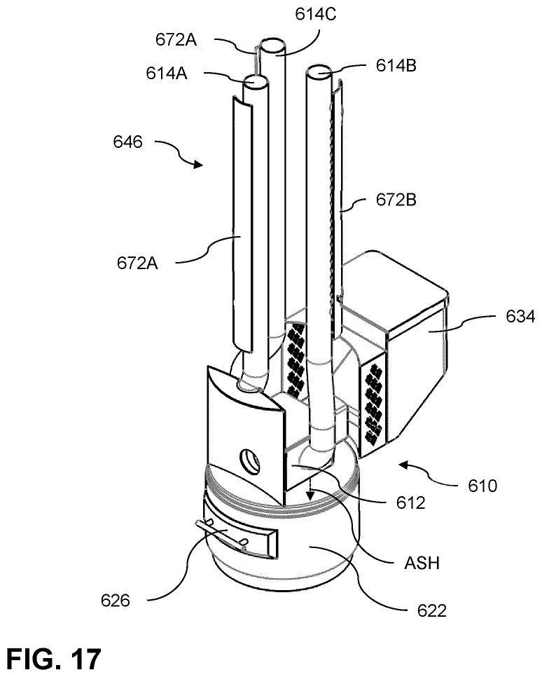

FIG. 16 is a perspective view of an exemplary outdoor space heater 600 having pellet system 610 of the type described herein. Outdoor space heater 600 may also be referred to as a “patio heater” and may be a radiant heating appliance for outdoor use. In some embodiments, pellet system 610 may include the components of pellet systems 10, 210, 310 and 410 previously described herein with a different configuration of radiators 614A-614C (shown in FIG. 17). For example, pellet system 610 may include combustion chamber 612 (shown in FIG. 17), one or more radiators 614A-614C, a blower, pellet hopper 634 and a conveyor as previously described herein.

Outdoor space heater 600 may include cover 616 enclosing heating volume 646 (chamber). Cover 616 may be air-permeable to allow combustion gas released from radiators 614A-614C out of heating volume 646 and also allow heat to be radiated out of heating volume 646. Cover 616 may serve as a safety screen that hinders direct physical contact of radiators 614A-614C by people or other objects outside of heating volume 646. Cover 616 may include one or more side walls with openings formed therethrough. For example, wall(s) of cover 616 may include a metallic wire mesh defining the openings or may otherwise be perforated. The openings may be of uniform size and shape or may be of different sizes and/or shape.

Cover 616 may include heat deflecting upper cap 620 which may be substantially air-impermeable. Cap 620 may include an unperforated metallic sheet or plate that hinders heat from escaping upwardly from heating volume 646. It is understood that the configuration of cover 616 may be selected based on the desired escape direction of radiant heat from heating volume 646 by selecting the size and location of perforated and unperforated walls of cover 616.

Cover 616 may have a generally cylindrical or other shape and may enclose radiators 614A-614C disposed within heating volume 646. Cover 616 and associated heating volume 646 may be disposed vertically above base 622 of outdoor space heater 600. For example, cover 616 may be adapted to interface (i.e., engage) with an upper side of housing 624.

Housing 624 may house combustion chamber 612 and optionally other components of pellet system 610. Housing 624 may include a cut-out for accommodating (e.g., digital) controller 664 operatively coupled to pellet system 610 so that operating parameters such as heat output and run time of pellet system 610 may be controlled. Controller 664 may provide an operator interface for adjusting and/or monitoring one or more operating parameters of pellet system 610.

FIG. 17 is a perspective view of outdoor space heater 600 with cover 616 removed to illustrate heating volume 646, and also with housing 624 and controller 664 removed. Combustion chamber 612 may be mounted on top of base 622. Outdoor space heater 600 may include a blower to push air into combustion chamber 612 and also cause the combustion gas to be pushed out of combustion chamber 612 and into radiator(s) 614A-614C. In some embodiments, pellet system 610 may include a valve as described above for selectively directing and blocking flow of combustion gas into one or more radiators 614A-614C.

Base 622 may include ash receptacle 626 located beneath combustion chamber 612 for receiving ash (e.g., spent pellet fuel) from combustion chamber 612. In some embodiments, ash receptacle 626 may be defined by a drawer or tray which is movably received into base 622 and which extends under combustion chamber 612. In some embodiments, a floor of combustion chamber 612 may include one or more apertures establishing communication between the interior of combustion chamber 612 and ash receptacle 626. The ash formed inside of combustion chamber 612 may fall into ash receptacle 626 via the aperture(s) due to the influence of gravity as shown by arrow labeled as “ASH”. The aperture(s) in the floor of combustion chamber 612 may be sized to permit the passage of ash particles while preventing pellets from falling into ash receptacle 626. In some embodiments, the floor may include a screen or a perforated sheet.

Radiators 614A-614C may be elongated and may each include a straight tubular portion that extends substantially vertically within heating volume 646. The straight tubular portions of radiators 614A-614C may be substantially parallel to one another. In some embodiments, the straight tubular portions may each have a length that represents at least a majority of the total length of the respective radiator 614A-614C. In some embodiments, radiators 614A-6140 may have bends and additional straight tubular portions.

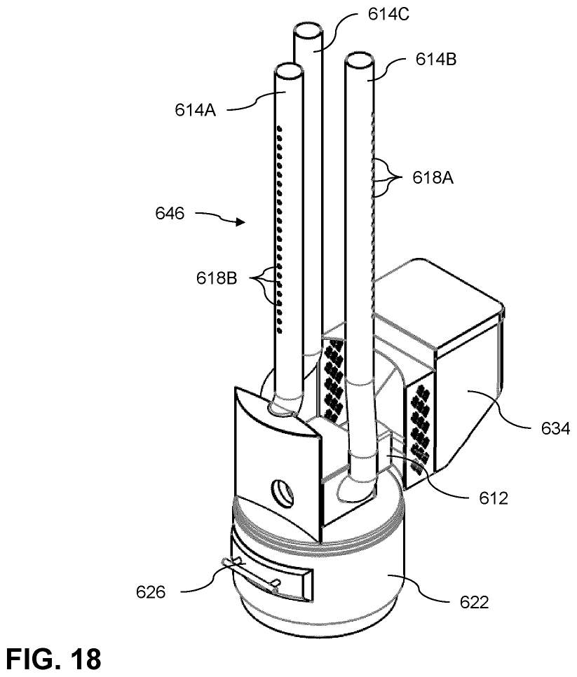

Outdoor space heater 600 may include heat deflectors 672A-672C that may be respectively disposed adjacent respective radiators 614A-6140. Heat deflectors 672A-672C may be attached to radiators 614A-6140 and positioned to intersect an axis defining orientation of discharge outlets 618 (shown in FIG. 18) of radiators 614A-614C. Heat deflectors 672A-672C may include metallic (e.g., stainless steel) plates or sheets. Heat deflectors 672A-672C may block flames discharged from radiators 614A-614C and/or disperse heat released by radiators 614A-614C.

FIG. 18 is a perspective view of outdoor space heater 600 of FIG. 16, with cover 616, housing 624, controller 664 and heat deflectors 672A-672C removed. FIG. 18 shows exemplary discharge outlets 618A, 618B respectively distributed along straight tubular portions of radiators 614A and 614B. Radiator 614C may also include similar discharge outlets. It is understood that discharge outlets 618A, 618B may each include a hole or an elongated slit. In some embodiments, discharge outlets 618A, 618B may be disposed on side(s) of respective radiators 614A-6140 to provide one or more desired principal directions of heat release from heating volume 646.

During operation of outdoor space heater 600, combustion gas and flames generated inside combustion chamber 612 from the combustion of pellets may be pushed into radiators 614A-6140 using a blower. Radiators 614A-614C may become heated by the combustions gas and then radiate heat in the outdoor space via the perforated side walls of cover 616.

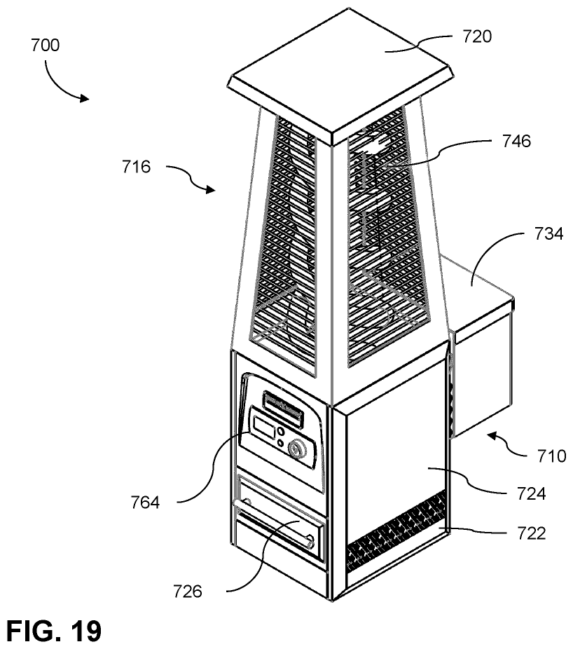

FIG. 19 is a perspective view of another exemplary outdoor space heater 700, similar to outdoor space heater 600, showing another exemplary configuration of radiators 714A, 714B, housing 724, cover 716 and hopper 734. Outdoor space heater 700 may include pellet system 710 having components of pellet systems 10, 210, 310 and 410 previously described herein.

Cover 716 is shown as having a tapered rectangular shape (e.g., square-based pyramid) and may have one or more air-permeable (e.g., perforated, meshed) side walls. Cover 716 may enclose radiators 714A, 714B disposed within heating volume 746 (chamber). Cover 716 may include heat deflecting upper cap 720 which may be substantially air-impermeable. Cap 720 may include an unperforated metallic sheet or plate that hinders heat from escaping upwardly from heating volume 746.

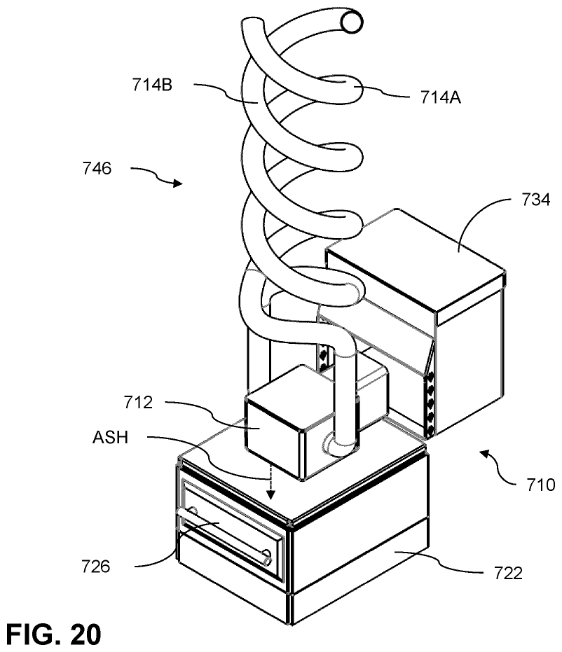

Housing 724 may house combustion chamber 712 (shown in FIG. 20) and optionally other components of pellet system 710. Housing 724 may include a cut-out for accommodating (e.g., digital) controller 764 operatively coupled to pellet system 710.

FIG. 20 is a perspective view of the exemplary outdoor heater 700 with cover 716 removed to illustrate heating volume 746, and also with housing 724 and controller 764 removed. Combustion chamber 712 may be mounted on top of base 722. Outdoor space heater 700 may include a blower to push air into combustion chamber 712 and also cause the combustion gas to be pushed out of combustion chamber 712 and into radiator(s) 714A, 714B.

Base 722 may include ash receptacle 726 located beneath combustion chamber 712 for receiving ash (e.g., spent pellet fuel) from combustion chamber 712. In some embodiments, ash receptacle 726 may be defined by a drawer or tray which is movably received into base 722 and which extends under combustion chamber 712. In some embodiments, a floor of combustion chamber 712 may include one or more apertures establishing communication between the interior of combustion chamber 712 and ash receptacle 726. The ash formed inside of combustion chamber 712 may fall into ash receptacle 726 via the aperture(s) due to the influence of gravity as shown by arrow labeled as “ASH”. The aperture(s) in the floor of combustion chamber 712 may be sized to permit the passage of ash particles while preventing pellets from falling into ash receptacle 726. In some embodiments, the floor may include a screen or a perforated sheet.

Radiators 714A, 714B may each include one or more straight tubular portions, bends and/or helical tubular portions. In some embodiments, outdoor space heater 700 may include one or more radiators 714A, 714B having respective helical tubular portions where each helical tubular portion may have a length that represents at least a majority of the total length of the respective radiator 714A, 714B. In some embodiments, the helical tubular portions of radiators 714A, 714B may be intertwined about a central axis that extends substantially vertically above base 722. Radiators 714A, 714B may each have one or more discharged outlets (not shown) disposed in their respective helical tubular portions.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the systems and methods are described in relation to cooking grills but it is understood the systems and methods described herein are also applicable to other pellet-fired appliances such as outdoor heaters and fireplaces. Yet further modifications could be implemented by a person of ordinary skill in the art in view of the present disclosure, which modifications would be within the scope of the present technology.

1. A cooking grill comprising:
a cooking chamber; and
a pellet-fired heating system for heating the cooking chamber, the pellet-fired heating system including:
a combustion chamber in which combustion gas is generated from a combustion of fuel pellets, the combustion chamber including a fuel inlet for receiving the fuel pellets into the combustion chamber, an air inlet for receiving air into the combustion chamber, and a combustion gas outlet for discharging combustion gas from the combustion chamber;
a radiator extending into the cooking chamber, the radiator including an internal passage in fluid communication with the combustion gas outlet of the combustion chamber, and a discharge outlet for discharging the combustion gas from the internal passage; and
a blower in fluid communication with the air inlet of the combustion chamber and configured to: push air into the combustion chamber via the air inlet and push the combustion gas out of the combustion chamber via the combustion gas outlet.

2. The cooking grill of claim 1, wherein the radiator is a first radiator, the internal passage is a first internal passage and the discharge outlet is a first discharge outlet, the system comprises:
a second radiator having a second internal passage in fluid communication with the combustion chamber, the second radiator having a second discharge outlet for discharging the combustion gas from the second internal passage; and
a valve actuatable to change proportions of combustion gas pushed into the first and second radiators.

3. The cooking grill of claim 2, wherein the valve is disposed inside the combustion chamber.

4. The cooking grill of claim 2, wherein a straight portion of the first internal passage of the first radiator is substantially parallel to a straight portion of the second internal passage of the second radiator.

5. (canceled)

6. The cooking grill of claim 1, comprising a conveyor in communication with the fuel inlet of the combustion chamber and operable to deliver the fuel pellets to the combustion chamber, wherein the conveyor is disposed inside a conduit establishing fluid communication between the blower and the air inlet.

7. (canceled)

8. The cooking grill of claim 1, comprising a heat deflector adjacent the radiator, the heat deflector intersecting an axis defining orientation of the discharge outlet.

9. The cooking grill of claim 1, wherein the fuel pellets are a first fuel of a first fuel type and the cooking grill includes a burner for heating the cooking chamber, the burner being configured to facilitate combustion of a second fuel of a second fuel type different from the first fuel type.

10. The cooking grill of claim 9, wherein the burner is a gas burner.

11. The cooking grill of claim 9, wherein the burner and the radiator are disposed inside the cooking chamber.

12. The cooking grill of claim 11, wherein:
the burner and the radiator are elongated; and
the burner and the radiator are oriented transversely to each other.

13. An outdoor space heater comprising:
a heating volume; and
a pellet-fired heating system for heating the heating volume, the pellet-fired heating system including:
a combustion chamber in which combustion gas is generated from a combustion of fuel pellets, the combustion chamber including a fuel inlet for receiving the fuel pellets into the combustion chamber, an air inlet for receiving air into the combustion chamber, and a combustion gas outlet for discharging combustion gas from the combustion chamber;
a radiator extending into the heating volume, the radiator including an internal passage in fluid communication with the combustion gas outlet of the combustion chamber, and a discharge outlet for discharging the combustion gas from the internal passage; and
a blower in fluid communication with the air inlet of the combustion chamber and configured to: push air into the combustion chamber via the air inlet and push the combustion gas out of the combustion chamber via the combustion gas outlet.

14. (canceled)

15. The outdoor space heater of claim 13, comprising an air-permeable cover enclosing the heating volume, wherein the cover includes one or more walls made of a metallic mesh.

16.-19. (canceled)

20. The outdoor space heater of claim 13, wherein the radiator has a helical tubular portion.

21. The outdoor space heater of claim 20, wherein:
the radiator is a first radiator;
the helical tubular portion is a first helical tubular portion;
the outdoor space heater includes a second radiator extending into the heating volume; and
the second radiator includes a second helical tubular portion intertwined with the first helical tubular portion.

22. (canceled)

23. (canceled)

24. A pellet-fired heating system comprising:
a combustion chamber in which combustion gas is generated from a combustion of fuel pellets, the combustion chamber including a fuel inlet for receiving the fuel pellets into the combustion chamber, an air inlet for receiving air into the combustion chamber, and a combustion gas outlet for discharging combustion gas from the combustion chamber;
a radiator extending into a space to be heated, the radiator including an internal passage in fluid communication with the combustion gas outlet of the combustion chamber, and a discharge outlet for discharging the combustion gas from the internal passage; and
a blower in fluid communication with the air inlet of the combustion chamber and configured to: push air into the combustion chamber via the air inlet and push the combustion gas out of the combustion chamber and into the radiator via the combustion gas outlet.

25. The pellet-fired heating system of claim 24, wherein the radiator is a first radiator, the internal passage is a first internal passage and the discharge outlet is a first discharge outlet, the system comprises:
a second radiator having a second internal passage in fluid communication with the combustion chamber, the second radiator having a second discharge outlet for discharging the combustion gas from the second internal passage; and
a valve actuatable to change proportions of combustion gas pushed into the first and second radiators.

26. The pellet-fired heating system of claim 25, wherein the valve is disposed inside the combustion chamber.

27. The pellet-fired heating system of claim 25, wherein a straight portion of the first internal passage of the first radiator is substantially parallel to a straight portion of the second internal passage of the second radiator.

28.-30. (canceled)

31. The pellet-fired heating system of claim 24, wherein the radiator has a proximal end proximal to the combustion chamber and a distal end distal of the combustion chamber, the distal end of the radiator being capped.

32. The pellet-fired heating system of claim 24, wherein the internal passage includes a first straight portion, a bend and a second straight portion disposed series.

33. The pellet-fired heating system of claim 32, wherein the first and second straight portions are substantially perpendicular.

34.-50. (canceled)
